(19) United States
(12) Patent Application Publication
(10) Pub. No.: US 2009/0287789 A1
(43) Pub. Date: Nov. 19, 2009

(54) Web browser accessible MODBUS TCP/IP activity log

(75) Inventors: Randi Sue Dolan, Murfreesboro, TN (US); Timothy Greg Curray, Murfreesboro, TN (US)

Correspondence Address: SCHNEIDER ELECTRIC / SQUARE D COMPANY;LEGAL DEPT. - I.P. GROUP (NP), 1415 S. ROSELLE ROAD, PALATINE, IL, 60067, US

(73) Assignee: Square D Company

(21) Appl. No.: 12/152,793

(22) Filed: May 16, 2008

(51) Int. Cl. G06F 15/16

(52) U.S. Cl. 709/208

(57) ABSTRACT

A system and methods for recording Modbus communications. An example system includes a master controller and a gateway device coupled to a network. A slave device capable of Modbus communications is provided. A gateway device is coupled to the network. The gateway device includes a slave communications interface coupled to the slave device and a log that records data relating to communications between the master controller and the slave device. The data includes a network address relating to the master controller and a Modbus address of the slave device.

### FIELD OF THE INVENTION

Aspects disclosed herein relate generally to data logging systems, and, in particular, to a web-accessible MODBUS® activity log.

### BACKGROUND

Microprocessor-based electrical power distribution equipment such as switchgear, switchboards, panelboards, and motor control centers accumulate considerable amounts of information concerning the electrical distribution systems to which they are connected, as well as the power equipment itself. A common requirement for such equipment is the performance of regular maintenance and the generation and maintenance of up-to-date records of all testing and improvements performed. This is currently done via manual means or by entering data into a computer-based “maintenance log.” These can be misplaced or mismanaged, with uncertainty regarding which documents reflect the official records, which is the latest copy, who is responsible for a given entry in the log, etc.

Today's utility monitoring systems provide end-users with the capability to remotely monitor a variety of equipment via automatic monitoring devices. This allows more accurate data and decreases human resource requirements. Industrial automation, monitoring, energy management, and control systems include many microprocessor or microcontroller-based monitoring devices which communicate with each other, as well as with other computers, via the MODBUS® (hereafter “Modbus”) communication protocol. The Modbus communication protocol is used with various slave devices that respond to read and write requests from a master controller. Among the features provided by this communication protocol includes a means for the user to access data from and/or configure these intelligent slave devices. Historically, the Modbus physical layer was either an RS-232 or RS-485 serial connection from the slave device to the master controller. Recently, however, the Modbus protocol has been implemented over Ethernet, wrapped in a TCP/IP format, which provides the ability to access these devices from potentially anywhere via a network. The network configuration for use of the Modbus protocol wrapped in a TCP/IP format includes a gateway device that has a serial interface to receive data from the slave devices and an Ethernet interface to share the data with networked devices. Although convenient, this ability to access a slave device remotely provides an opportunity for accidental or unexpected access that may modify the data in the devices. Without any ability to track the communications between the master controller and the slave devices, users cannot readily perform diagnostics on the equipment monitored and/or controlled by the slave devices or determine the errors based on the past data and communications from the slave devices.

Currently, there is no way for users to review the Modbus TCP/IP communication history between a master controller and slave devices in industrial automation, monitoring, and control systems. The communication history data is not stored for users to retrieve in such systems. Thus, a means to store and retrieve the Modbus TCP/IP communication history for a Modbus-enabled slave device is needed. Another need is for a system that allows Modbus communications history data to be available to the user in an easy to view, historically grouped list. There is also a need for an automated logging system of Modbus communications over a TCP/IP connection. Another need is a web-accessible interface to a stored log of Modbus communications over a TCP/IP connection.

### BRIEF SUMMARY

According to one example, a method of recording Modbus communications for a system having a master controller coupled to a gateway device is disclosed. The gateway device is coupled to a slave device. A network communications link is established between the master controller and the gateway device. A serial communications link is established between the gateway device and the slave device. A read or write request for the slave device is received from the master controller. A Modbus connection is created between the master controller and the slave device. Data associated with the request, including a network address relating to the master controller, a Modbus address of the slave device, and the date time of the request, is recorded in a log.

Another example is a system for recording Modbus communications. The system includes a master controller, a network coupled to the master controller and a slave device capable of Modbus communications. A gateway device is coupled to the network. The gateway device includes a slave communications interface coupled to the slave device. The gateway device includes a log that records data relating to communications between the master controller and the slave device. The data includes a network address relating to the master controller and a Modbus address of the slave device.

Another example disclosed is a machine readable medium having stored thereon instructions for recording Modbus communications between a master controller and a slave device. The stored instructions include machine executable code, which, when executed by at least one machine processor, causes the machine to establish a network communications link between the master controller and a gateway device. The stored instructions cause the machine to establish a serial communications link between the gateway device and the slave device. The stored instructions cause the machine to receive a read or write request for the slave device from the master controller. The stored instructions cause the machine to create a Modbus connection between the master controller and the slave device. Data associated with the request, including a network address relating to the master controller, a Modbus address of the slave device, and the date and time of the request, is recorded in a log.

The foregoing and additional aspects of the present invention will be apparent to those of ordinary skill in the art in view of the detailed description of various embodiments, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is functional block diagram of a utility data monitoring system that includes slave devices that communicate with a master device via a Modbus TCP/IP communications protocol;

FIG. 2 is a functional block diagram of a gateway device in FIG. 1 that stores the log of Modbus TCP/IP communications; and

FIG. 3 is a flow diagram of an exemplary process algorithm according to the aspects disclosed herein.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

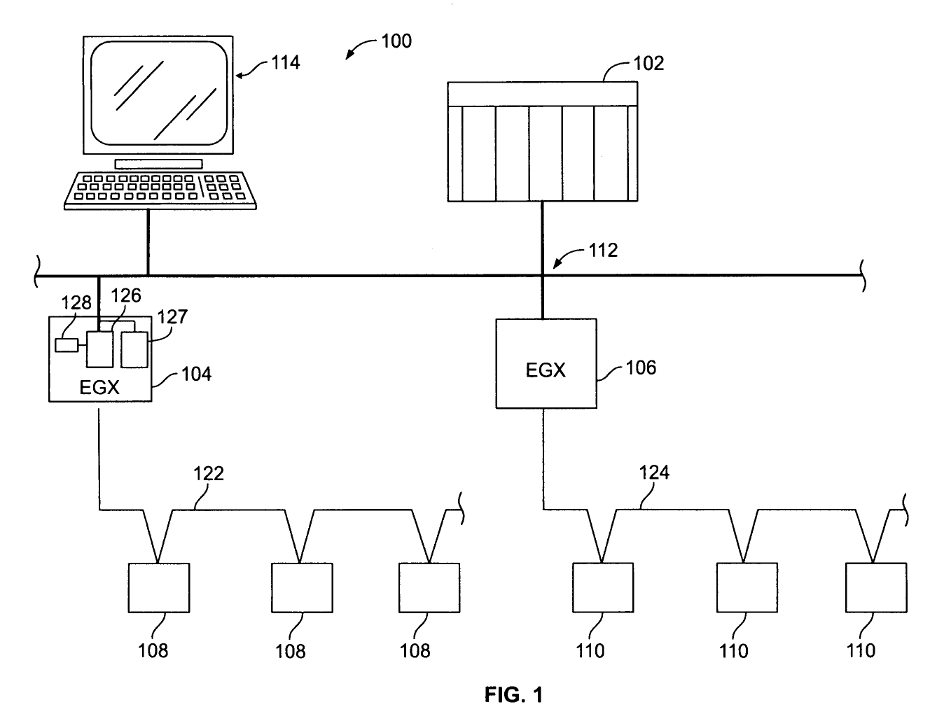

FIG. 1 shows a utility data monitoring system 100 that includes a master controller 102 coupled to a gateway device 104 and a gateway device 106. In this example, the gateway device 104 is coupled to slave control devices 108 such as transformer temperature controllers, relays or trip units for controlling electrical equipment. In this example, the gateway device 106 is coupled to slave energy-management devices 110 such as power meters and circuit monitors. Alternatively, a programmable logic controller (PLC) may be used as a control slave device or an energy-management slave device. The slave devices 108 and 110 are each capable of Modbus communication. Generally, the slave devices 108, 110 may be controller- or microprocessor-based intelligent electronic devices (IEDs). Each of the slave devices 108 and 110 has an identification address according to the Modbus serial communications protocol, a well known standard protocol in the industrial automation, monitoring, and control systems. It is to be understood that fewer or additional slave devices may be used with the system 100. Further, the master controller 102 may control additional gateway devices that in turn communicate with additional slave devices via a serial line. Further, additional master controllers like the master controller 102 may be coupled to the network 112 to provide separate monitoring and control functions. The master controller 102 and the gateway devices 104 and 106 are coupled to a network 112. The master controller 102 in this example is a dedicated programmable logic controller that transmits and receives Modbus communications from the network 112 via a TCP/IP interface. Examples of a suitable Modbus TCP/IP master controller 102 are the Vision2x0 controller available from Unitronics based in Israel and the Modicon Quantum and the Modicon Momentum available from Schneider Electric.

A computer or workstation 114 that includes a web browser application is also coupled to the network 112. In this example, the network 112 is an Ethernet-based network or some other form of private local-area network (LAN). The private LAN is typically coupled to a wide-area network (WAN) such as the Internet that can include additional network nodes such as computers or workstations operating web browsers. In this example, the communications on the network 112 between the master controller 102, gateway devices 104 and 106, and the workstation 114 are standard TCP/IP communications. The computers or workstations coupled to the network 112 such as the workstation 114 may be any computers operating web browser programs such as Internet Explorer® available from Microsoft Corp. and may access and display a log of Modbus communications between the master controller 102 and the slave devices 108 and 110 via the respective gateway devices 104 and 106. Alternatively, instead of the master controller 102, a properly configured computer such as the workstation 114 can serve as the master controller for the slave devices 108 or 110 via the gateway devices 104 and 106.

In this example, the slave devices 108 are control devices for utility equipment such as relays, circuit breakers or trip units that are controlled remotely by communications from the master controller 102 according to the Modbus protocol. Such devices may also allow data output according to the Modbus protocol to be read relating to operating characteristics of the devices. In this example, the slave devices 110 are power monitoring devices such as power meters or circuit monitors. The utility being monitored by the utility data monitoring system 100 can be any of the five utilities designated by the acronym, WAGES, or water, air, gas, electricity, or steam in this example. Each monitoring device represented by the slave devices 110 measures characteristics of the utility, and quantifies these characteristics into data that can be further analyzed by software. In this example, the data is output by the slave devices 110 in a format according to the Modbus protocol. For example, the slave device 108, 110 may measure power, energy, volume per minute, volume, temperature, pressure, flow rate, or other characteristics of water, air, gas, electricity, or steam utilities and then output data relating to such measurements. In the electrical context, the slave device 108, 110 may be a PowerLogic® Series 3000/4000 Circuit Monitor or a PowerLogic® ION7550/7650 Power and Energy Meter available from Schneider Electric or any other suitable monitoring device such as an intelligent electronic device (IED), a metering device, or a power meter. The slave devices 108, 110 are capable of communicating according to the Modbus serial communications protocol over respective serial lines 122, 124 to the respective gateway devices 104, 106.

In the above example, the data measured or monitored by the slave devices 110 is output in Modbus format by the slave devices 110. On receiving a read request from the master controller 102, the summoned slave device 110 sends its measured data over the serial line 124 to the gateway device 106, which sends it over the network 112 to the master controller 102. Alternatively, control signals or data from the master controller 102 may be written or sent to the slave devices 108 and 110 via the respective gateway devices 104 and 106. For example, a write request can be initiated by the master controller 102 to command a control device such as one of the slave devices 108 to turn on a relay. The master controller 102 sends the write request over the network 112 to the gateway device 104, which in turn sends the requested control data to be written over the serial line 122 to the proper slave device 108.

In this example, the gateway devices 104 and 106 are identical and although the below description is specific to the gateway device 104, it is equally applicable to the gateway device 106. The gateway device 104 is an Ethernet-capable device that includes an integral Modbus TCP/IP server 126 and an integral web server 127, both of which will be explained in greater detail below. The gateway device 104 communicates over the network 112 with the master controller 102 and converts between the serial Modbus communications protocol associated with the slave devices and the Ethernet TCP/IP protocol of the network 112. The master controller 102 reads data from and writes data to the slave devices 108, 110 according to the Modbus TCP/IP protocol over Ethernet through the gateway devices 104 and 106, respectively. A Modbus TCP/IP history log 128 resides on-board gateway devices 104 and 106, respectively. The history log 128 is accessible via a standard web browser such as one running on the workstation 114 and provides a “window” into the communication history of the slave devices 108 coupled to the gateway device 104. In this example, the history log 128 is a table of data related to communications between the master controller 102 and the slave devices 108.

A web server such as the server 127 typically stores web pages, i.e., HTML (hypertext markup language) pages or files, that can be retrieved by a web browser running on a network computer such as the workstation 114. In this example, the web server 127 has a webpage specifically formatted for displaying the log 128 for the slave devices 108. Each web server, such as the web server 127, has a unique IP address and optionally a domain name, and sends web pages when addressed by a web browser on a device on a network such as the network 112. The server 126 in conjunction with the gateway device 104 provides gateway functions by allowing Ethernet access to the Modbus serial communications to the slave devices 108.

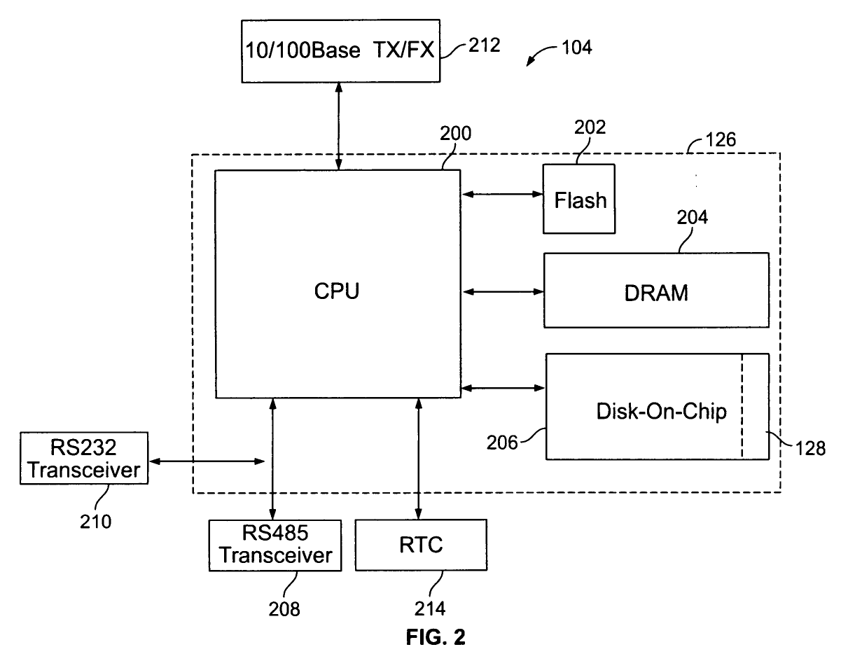

FIG. 2 is a block diagram of the gateway device 104. The gateway device 104 includes a CPU 200, a flash memory 202, a DRAM 204, a disk-on-chip memory 206, an RS-485 transceiver 208, an RS-232 transceiver 210, an Ethernet interface 212 and a real time clock 214. The Ethernet interface 212 has one or more on-board Ethernet ports, e.g., one for a 10/100Base TX Twisted Pair connection and another for a 100Base Fx connection. The Ethernet interface 212 is coupled to the network 112 in FIG. 1. In this example, the RS-485 transceiver 208 has an RS-485 serial port for coupling the serial communications line 122 to the slave devices 108 shown in FIG. 1. The RS-485 port of the RS-485 transceiver 208 typically supports multiple devices without a repeater. Similarly, slave devices (not shown in this example) can be coupled to a serial line coupled to the RS-232 transceiver 210. The real time clock 214 provides time data to stamp entries in the log 128 as will be explained below.

The processor 200 operates the Modbus TCP/IP server 126 of the gateway device 104. The server 126 operates a content management system that provides a centralized location to store Modbus data, or any other information in the form of the log 128, about the slave devices 108 and data from the slave devices 108. The log 128 and other server-based applications and data are stored on the disk-on-chip memory 206. The content management system resides onboard the server 126 and is integrated into the gateway device 104, one example of which is the PowerLogic® EGX family of devices available from Schneider Electric.

The processor 200 in FIG. 2 collects, stores, and distributes log data relating to Modbus communications between the master controller 102 and the slave devices of the system 100 such as the slave devices 108. In this example, the log 128 is in the form of a table that is maintained by the Modbus TCP/IP server 126 in the disk-on chip-memory 206. Alternatively, the log 128 can be stored in the flash memory 202. The log 128 is viewable via a web browser program. In this example, the data in the log 128 and the corresponding web page is relatively simple for efficient use of the disk-on-chip memory 206. The log 128 may be subject to a first in first out (FIFO) procedure to handle an overflow of data. If the log 128 is full, the oldest entry will be discarded for a new log data entry. Alternatively, the log 128 may be subject to a fill-and-hold procedure whereby entries are recorded in the log 128 until the log 128 is full. Once the log 128 is full, no more entries will be recorded unless the user resets the log. This is useful if the user wishes to download the data to another device with more storage (a PC, for example) on a scheduled basis, then clear the log 128. This can give the user the option of storing all of the data recorded in the log 128, if downloading is done on a regular basis.

However, a computer or other device on the network 112 with greater memory capability such as the workstation 114 can also function as a web server and provide more data storage for a log. With more dedicated memory, the log data may be presented to the user as a wiki or blog, which is served to the user via the web server's HMI (human-machine interface), using the HTTP protocol to a workstation running a browser program such as the workstation 114 in FIG. 1. Of course, the processes described are not limited to applications utilizing the Internet or World Wide Web, but rather can be used in any type of network to which the electrical power distribution equipment is connected.

This information in the log 128 is then presented to the user (utility administrator, for example) via a standard web browser such as that running on the workstation 114. A user logs into the HTML user interface of the web server 127 associated with the gateway 104 coupled to the desired slave device, such as one of the slave devices 108, and then uses the standard navigation of the browser to view the log 128 in a tabular format.

The Modbus TCP/IP server 126 logs each request from a Modbus TCP/IP master such as the master controller 102 to communicate with a Modbus slave device such as one of the slave devices 108 in the log 128 along with the date and time associated with the request. In this example, the requests are Modbus read or write requests for either single or multiple registers. Alternatively, the requests may be Modbus read/write functions for single or multiple registers. Upon request from a user, the Modbus TCP/IP communication history in the log 128 is compiled into a web page that is accessible from any standard web browser such as one running on the workstation 114 in FIG. 1. The historical data for the slave devices 108 may then be sorted in the view by user interests (e.g., Top Talkers, Number of Reads, Number of Writes). Further data processing applications may be run on the workstation 114 to analyze the communications history data associated with the slave devices 108. For example, the communications history data allows a user to isolate and analyze problematic specific slave devices 108. The time that communications are received coupled with the identity of the devices that initiated the communications may assist in diagnostic and maintenance analysis.

A primary application for the Modbus TCP/IP communication history log 128 is to provide an easily accessible history of communication data for informational and troubleshooting activities. Thus, in this example, the log 128 includes a table of the IP address(es) of the Modbus master controller(s) such as the master controller 102 that have connected to a slave device, such as the slave devices 108, the date and time the Modbus master controller 102 initiated a Modbus request with the slave device 108 via the Modbus TCP/IP server 126, whether the request was for a read and/or write, and the slave device IDs (identification numbers). To read the IP address of the master controller 102, the Modbus TCP/IP server 126 extracts the IP address that is embedded in the IP source field of the message frame from the master controller 102 and stores it in the log 128. Similarly, the Modbus TCP/IP server 126 also extracts the identification number of the slave device 108, 110 from the unit identifier field of the Modbus TCP/IP message frame from the master controller 102 and stores it in the log 128.

The log 128 may be in the form of a web log that is a website in which items are posted and displayed in chronological order. A typical web log is a hierarchy of text, images, media objects and data, arranged chronologically, that can be viewed via any web browser. A wiki is similar, lacking the chronological element but adding open editing to maintain a record of each individual change that occurs over time. Both the web log and the wiki facilitate an open exchange, collaboration, and automatic documentation. They both also permit the use of links to additional information, further enhancing the quality of the equipment documentation with little added effort. The use of a dated log format that is updated periodically is well-suited to a variety of user-interface tasks that can be executed using the embedded web server 127 in the gateway device 104.

It is preferred to restrict access to the Ethernet gateway by requiring user authentication at the web HMI. Authenticated users may or may not have access to the log 128, or may have read-only access to the log 128. The Ethernet gateway administrator controls access by defining users and groups, and then setting group permissions for each web page resident onboard the Ethernet gateway. This authentication mechanism enables the web server 127 to “know” who is accessing the log 128.

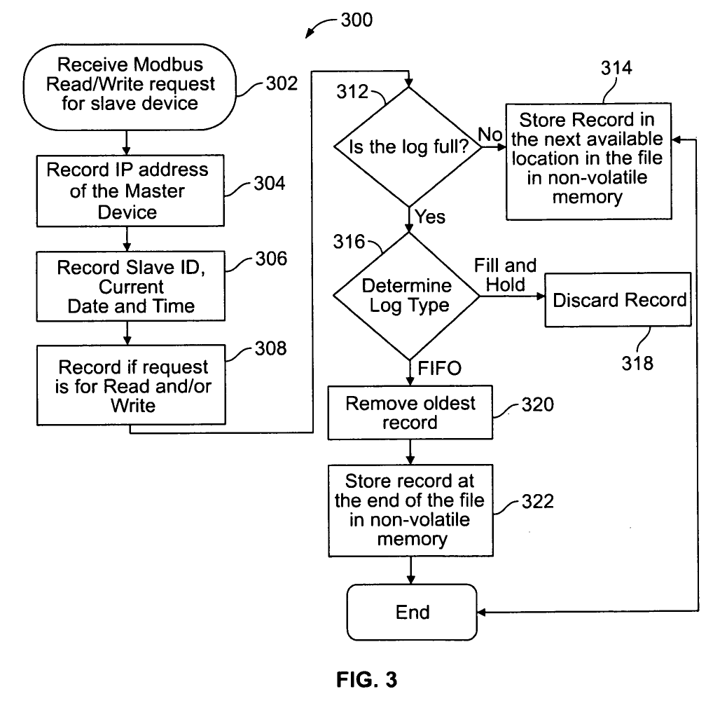

FIG. 3 is a flow diagram of components of an exemplary log algorithm 300 according to aspects disclosed herein. The log algorithm 300 may be run on the server 126 of the gateway device 104 in conjunction with the master controller 102 and may be part of the monitoring system 100. The blocks shown in these figures need not be carried out in the order depicted nor must all of the blocks necessarily be carried out in all aspects. The log algorithm 300 maintains and records the communications transactions between the master controller 102 and the slave devices 108 and 110 in FIG. 1.

Initially, the master controller 102 creates a Modbus TCP/IP socket connection to one of the gateway devices such as the gateway device 104 in FIG. 1. A request is received by the gateway device 104 for either a read or write request for one of the slave devices 108 in this example in FIG. 1 (302). The IP address of the master controller 102 is recorded by the log algorithm 300 (304). The log algorithm records identification information associated with the slave device 108, such as its Modbus address (306). The date and time of when the Modbus TCP/IP request by the master controller 102 to the slave device 108 was initiated is also recorded by the algorithm (306).

The log algorithm 300 determines whether the request is a read or write request and records the request as either a read request or a write request (308). The algorithm 300 then begins the process of storing the recorded data in a log entry in log 128 in the disk-on-chip memory 206.

In the process of storing the log entry in the log 128, the algorithm 300 determines whether the log 128 is full (312). If the log 128 is not full, the log record of the communications is stored in the next available location in the log 128 (314) and the algorithm ends. If the log 128 is full, the algorithm 300 determines whether the log type is first-in-first-out (FIFO) or fill-and-hold with regard to handling overflow (316). If the log type is a fill-and-hold type, the algorithm 300 discards the log record to be stored (318) and cannot add any new log records until the log 128 is cleared. If the log type is a FIFO type, the algorithm 300 removes the oldest log record in the log 128 (320) and stores the new log record at the end of the log 128 (322).

The logging aspects disclosed herein allow a network administrator of an industrial automation, monitoring, or control system to gain a historical understanding of communication activity between the master 102 and the slave devices 108, 110. The network administrator can view at a glance, for example, which slave devices are most active on the network or which slave devices have been modified. For example, a primary application of the slave devices 108 may be to function as circuit monitors to accumulate energy usage and to calculate energy demand. If this data is reset (zeroed), via a Modbus write, when the reset was not desired, this may cause an error in accounting applications with the utility. The log 128 is useful to investigate the cause of the reset.

Additionally, if a configuration of a slave device has been modified, the network administrator can review the log to determine which slave device was modified and when for troubleshooting purposes. Any accidental or unexpected access that may modify the data in a slave device can now be known quickly by the network administrator, increasing security and reducing troubleshooting efforts. For example, if an unexpected operation occurred on a slave device, the log could be used to investigate if a master controller caused this operation. Then, after pinpointing the offender, the reason for the unexpected operation, such as an error in programming, could be investigated further.

Any of these algorithms include machine readable instructions for execution by: (a) a processor, (b) a controller, and/or (c) any other suitable processing device. It will be readily understood that a gateway device 104 includes such a suitable processing device. Any algorithm disclosed herein may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine readable instructions represented in any flowchart depicted herein may be implemented manually. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A method of recording Modbus communications for a system having a master controller coupled to a gateway device, the gateway device coupled to a slave device, the method comprising:
establishing a network communications link between the master controller and the gateway device;
establishing a serial communications link between the gateway device and the slave device;
receiving a read or write request for the slave device from the master controller;
creating a Modbus connection between the master controller and the slave device; and
recording data associated with the request including a network address relating to the master controller and a Modbus address of the slave device in a log.

2. The method of claim 1 wherein the data includes read or write requests associated with the slave device, and the data recorded in the log may be sorted by statistical categories.

3. The method of claim 1, wherein a second slave device is connected to the gateway device, and wherein data relating to read or write requests for the second slave device and the Modbus address of the second slave device is recorded in the log.

4. The method of claim 1, wherein the gateway device includes a network interface coupled to master controller and a serial transceiver coupled to the slave device via a serial line.

5. The method of claim 1, further comprising:
formatting the data in the log in a web accessible format; and
allowing access to the log via a web browser enabled networked device.

6. The method of claim 5, wherein a web server on the gateway device manages the log.

7. The method of claim 1 wherein the log records the time the connection was created with the master controller.

8. The method of claim 1, wherein the log is updated through a first in first out process.

9. The method of claim 1, wherein the data recorded in the log is limited via a fill and hold procedure.

10. The method of claim 1, wherein the slave device is a utility control device or a utility equipment management device.

11. A system for recording Modbus communications, the system comprising:
a master controller;
a network coupled to the master controller;
a slave device capable of Modbus communications; and
a gateway device coupled to the network, the gateway device including a slave communications interface coupled to the slave device, and a log that records data relating to communications between the master controller and the slave device, the data including a network address relating to the master controller and a Modbus address of the slave device.

12. The system of claim 11 wherein the communications include read or write requests, and the data recorded in the log is sortable by statistical categories based on the communications.

13. The system of claim 11, further comprising a second slave device capable of Modbus communications coupled to the slave interface, wherein the log records communications between the second slave device and the master controller.

14. The system of claim 11, wherein the gateway device includes a server to maintain the log, the server formatting the data in the log in a web accessible format, and allowing access to the log via a web browser enabled device coupled to the network.

15. The system of claim 11, wherein the log records the time a connection was created with the master controller to the slave device.

16. The system of claim 11, wherein the log is updated through a first in first out process.

17. The system of claim 11, wherein the data recorded in the log is limited via a fill and hold procedure.

18. The system of claim 11, wherein the slave device is a utility control device or a utility equipment management device.

19. A machine readable medium having stored thereon instructions for recording Modbus communications between a master controller and a slave device, the stored instructions comprising machine executable code, which when executed by at least one machine processor, causes the machine to:
establish a network communications link between the master controller and a gateway device;
establish a serial communications link between the gateway device and the slave device;
receive a read or write request for the slave device from the master controller;
create a Modbus connection between the master controller and the slave device; and
record data associated with the request including a network address relating to the master controller and a Modbus address of the slave device in a log.
